(19) United States
(12) Patent Application Publication
(10) Pub. No.: US 2004/0083017 A1
(43) Pub. Date: Apr. 29, 2004

(54) Process and method for a dynamic rack creator and editor

(76) Inventors: Terrence Brown, Burtonsville, MD (US); Reginald Waters, Washington, DC (US); Floyd R. Pinder, Columbia, MD (US)

Correspondence Address: Terrence A. Brown, 14534 Beaker Court, Burtonsville, MD, 20866, US

(21) Appl. No.: 10/690,251

(22) Filed: Oct. 20, 2003

Related U.S. Application Data
(60) Provisional application No. 60/419,324, filed on Oct. 18, 2002.

(51) Int. Cl. G06F 19/00

(52) U.S. Cl. 700/97

(57) ABSTRACT

A process and method for an automated rack creator of network equipment based upon input of data to automatically scan a database server to acquire images and/or create images to determine the correct placement in the visual representation of the creation and update of a network rack and equipment dynamically (or in real-time) based upon coding and mathematical equations. The process provides the user a series of input methods or procedures to create, edit and view racks and equipment for the networking and telecommunications industries. The visual representation of the racks provides non-technical personnel with a tool to identify and provide input methods, eliminating the need to visit these networking and telecommunications rooms or offices.

This application is related to and claims the benefit of U.S. Provisional Application No. 60/419,324, filed Oct. 18, 2002, the teachings of which are hereby incorporated herein in their entirety, including all appendices.

### BACKGROUND OF THE INVENTION

1. Field of the Invention

This invention relates to the field of networking and telecommunications, and more specifically, to a process and method for a dynamic rack creator and editor.

2. Background

Various patents disclose methods for building racks for telecommunications and networking. U.S. Pat. No. 6,577,498, issued Jun. 10, 2003 to Land, et al., discloses a fully integrated computer rack mount system comprising of shelves and panels. This data can then be associated for building and the manufacture of a rack. U.S. Pat. No. 6,614,665, issued Sep. 2, 2003 to Witty, et al., discloses a cable management bracket for building a telecommunications rack for management of the cables associated with the building of telecommunications racks.

None of the two listed patents address the process and method of visual representation of racks and editing the changes to the equipment on the racks dynamically. This would include the networking equipment (regardless of the manufacturer) and telecommunications equipment (regardless of the manufacturer) residing in a data center, central office or switch room. In addition, these shortcomings address primarily the building of a rack, but not the method of data entry to change and edit the racks in real-time. Furthermore, these patents provide specifics on the rack itself and parts of the racks (brackets, shelves and panels).

There exists a need wherein a central processing unit (CPU) can be accessed for the purposes of editing rack and equipment information (via a series of input methods) residing in a database (either off-line or on-line) to create, edit and view racks and equipment for the networking and telecommunications industries. It is highly desirable to move, add and update changes to telecommunications and networking equipment automatically based upon input of data to automatically scan the database server to acquire images and/or create images to determine placement in the visual representation of the network rack. A need also exists to track the life cycle of the equipment to address these changes and future planning of the racks. The visual representation of the racks provides non-technical personnel with a tool to identify and provide input methods, eliminating the need to visit these networking and telecommunications rooms or offices.

There exists another need to eliminate the manual examination and input of changes of network and telecommunications equipment. In the past, the input has been performed manually on drawings by either a data center or central office technician. In the manual method, a rack is viewed in the field, and the technician visually locates racks of interest and manually sketches the missing areas of the rack and measures the distance of the space. The technician would then have to give the changes to a clerk to manually edit and/or create the racks in various programs to reflect changes to the network and telecommunications equipment will improve the speed and accuracy of the testing process. The manual method is time consuming and prone to errors and does not address placement of the changes into a database. An automated rack creator system will address improving the speed and accuracy of the rack and equipment changes in the field in real-time.

### SUMMARY OF THE INVENTION

Accordingly, several aspects of the present invention for a process and method for a dynamic rack creator and editor are:

a) It is an aspect of the present invention is to provide a method to involve a graphical user interface (GUI) allowing the user to input data to access a database server to acquire images and/or create images to determine the correct placement in the visual representation of the creation and/or update of a network rack and equipment dynamically (or in real-time).

b) It is another aspect of the present invention is to provide a method to automate the input of details of the network infrastructure, involving a series of racks and equipment. A further dependence on the manual input of rack and equipment information can lead to a series of input errors and/or missing or partial information being displayed.

c) It is a further aspect of the present invention is to provide a method to automate the update and/or creation of details of the network infrastructure, involving a series of racks and equipment in real-time (or dynamically).

d) It is an also an aspect of the present invention is to provide a method to track network rack and equipment within a central processing unit (CPU) that can be accessed by a database server for the purposes of accessing and input of moves, adds and changes records over time for historical data on equipment and maintenance purposes.

e) It is aspect of the present invention is to provide a method to conduct network planning on the data center, switch room, and central office, based upon the ability to see visually exactly what resides within each data center, switch room, and central office, via the Internet or Intranet.

f) It is a further aspect of the present invention is to provide a method to view the equipment details, including height, width and depth measurements in (“U” or units), inches or centimeters, and model numbers, serial numbers and other details.

g) It is an aspect of the present invention is to provide a method to track the life cycle of networking equipment and inventory records, whether its new, retired in place or moved, throughout the data center, switch room, and central office.

h) Yet another aspect of the present invention is to provide a method to group equipment, by equipment type, height, depth and width.

i) Still yet another aspect of the present invention is to provide a method to input the space and height requirements for both the racks and equipment by barcode readers, voice input, personal digital assistants, visually impaired input devices to create and edit racks dynamically.

j) It is an aspect of the present invention is to provide a method to input the equipment model numbers, barcode and serial numbers for the equipment by barcode readers, voice input, personal digital assistants, visually impaired people to create and edit racks dynamically.

k) It is another aspect of the present invention is to provide a method to search (or query) a database server for available equipment to place in open or vacant space on the rack, which meet a series of height, depth, width requirements.

l) It is a further aspect of the present invention is to provide a method to input and update the equipment and inventory records within an application server that can be accessed by a database server for the purposes of inventory, asset management and financial accounting of new, used and spare networking and telecommunications equipment.

Although the description above contains many specificities, these should not be construed as limiting the scope of the invention but merely providing illustrations of some of the presently preferred embodiments of this invention. Thus, the scope of the invention should be determined by the appended claims, rather than by the examples given.

### BRIEF DESCRIPTION OF THE DRAWINGS

FIG. 1 shows the visual representation of a rack

FIG. 2 shows the general flowchart (new racks) for the invention

FIG. 3 shows the general flowchart (existing racks-removing equipment) for the invention

FIG. 4 shows the general flowchart (existing racks-adding equipment) for the invention

FIG. 5 shows the general flowchart (existing racks-changing equipment) for the invention

FIG. 6 shows the block diagram (flow) for the invention

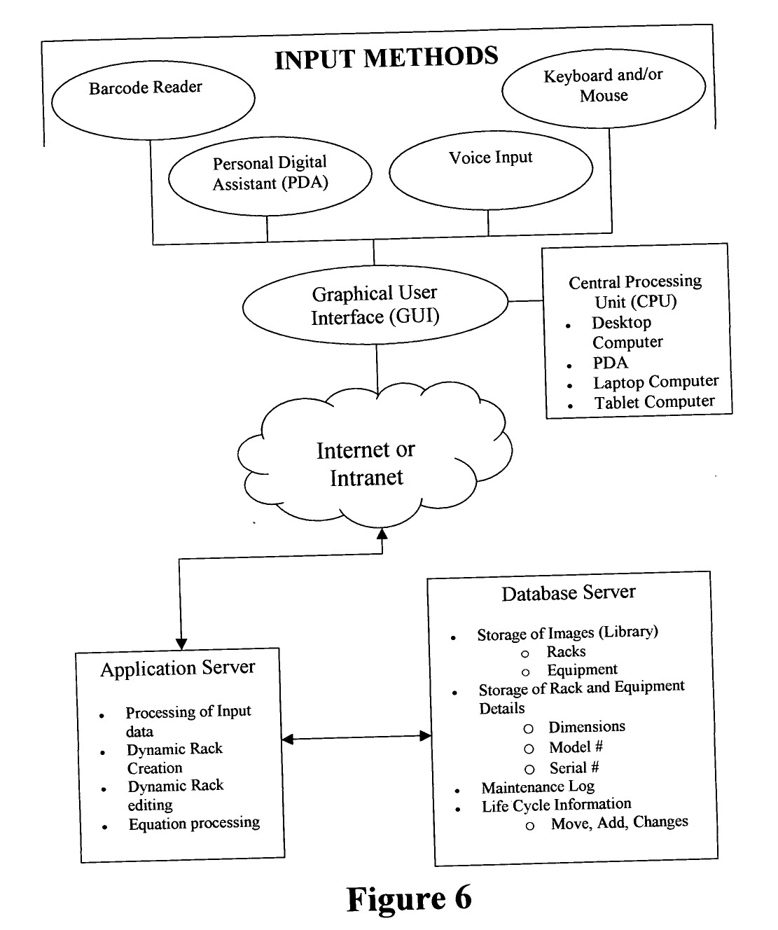

### REFERENCE NUMERALS IN DRAWING

| | |
|---|---|
| 10 | Rack Frame or Outline |
| 20 | Equipment |
| 30 | Vacant (available or open) Space |
| 40 | Position Numbers |
| 50 | Is this a new rack? |
| 60 | Go to the existing racks section |
| 70 | What is the type of equipment? Power, |
| | Switch, Transport, Other |
| 80 | What is the number of equipment to be |
| | added to the rack? |
| 90 | Do you want to build another rack? |
| 100 | Exit the new rack section |
| 110 | What is the name of equipment #1, 2, |
| | . . . ? |
| 120 | What is the model Number for |
| | equipment 1, 2, . . . ? |
| 125 | Equipment will not fit in the available |
| | space |
| 130 | What is the Serial Number for |
| | equipment 1, 2, . . . ? |
| 140 | What is the Barcode for equipment |
| | 1, 2, . . . ? |
| 150 | What are the Notes for equipment 1, |
| | 2, . . . ? |
| 160 | Do you want to add more |
| | equipment? |
| 170 | Is this an existing rack? |
| 180 | Are you adding, removing or |
| | changing equipment? |
| 190 | What is the position number on the |
| | rack? |
| 200 | Do you want to remove additional |
| | equipment form this rack? |
| 210 | Do you want to add or change |
| | equipment form this rack? |
| 220 | Do you want edit another existing |
| | rack? |
| 230 | Exit the existing rack section |
| 240 | What is the name of the equipment |
| | that you want to add in its place? |
| 250 | Where do we move the equipment |
| | to? |

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

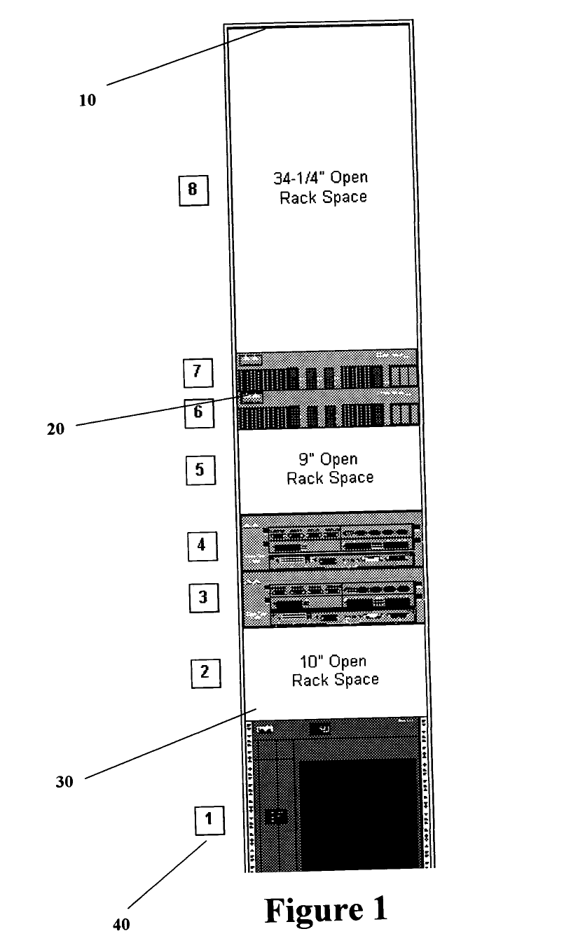

Description—FIG. 1

A preferred embodiment of the process and method for a dynamic rack creator and editor is illustrated by turning first to FIG. 1 (visual representation of a rack). The rack has the following reference numbers (10), (20), (30), (40), each of these components provides the user with the essential information to be inputted. The ability to retrieve network and telecommunications equipment and inventory in a format that is user-friendly and is depicted visually and in a method that increases the productivity of the user(s) by simplifying the update of records and inventory improve the workflow process and tasks for the user(s).

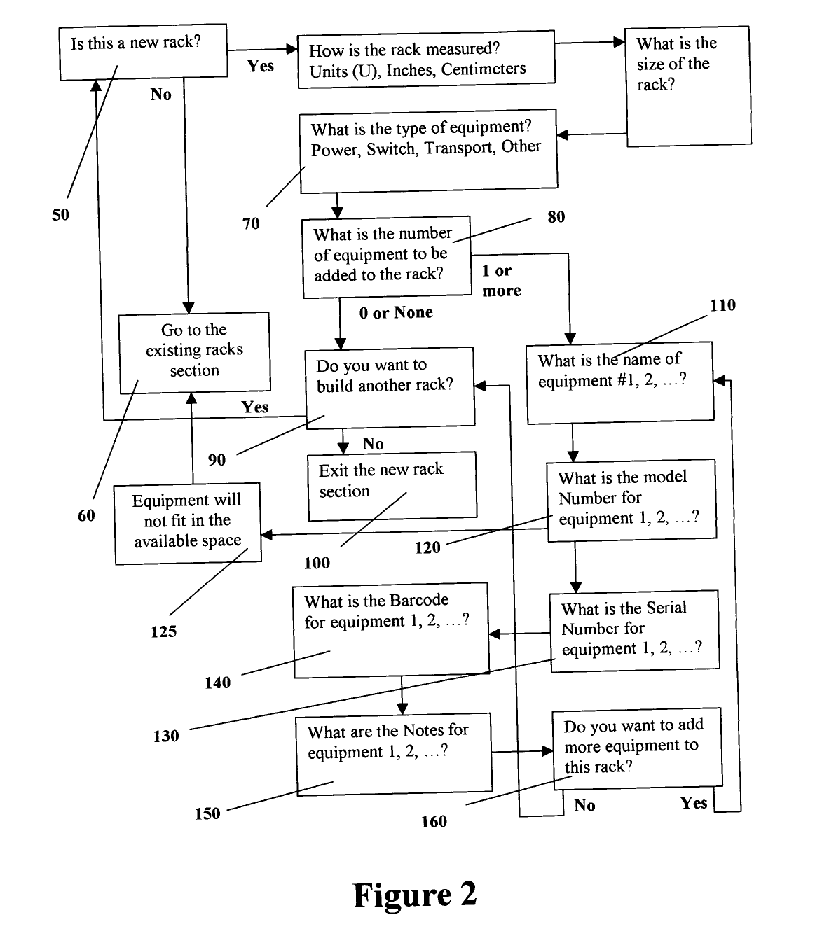

Description—FIG. 2

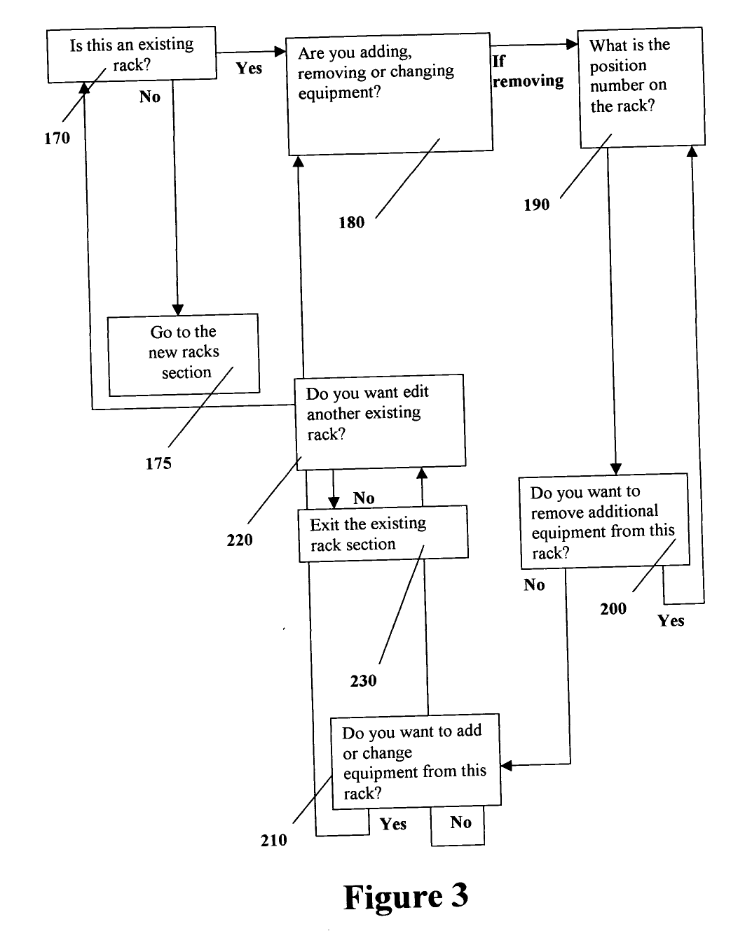

The user has the ability to create new racks, with the rack frame only (10) (FIG. 1), by answering the question, is this a new rack? (50), shown on FIG. 2. The user has two choices to start viewing the dynamic creation of a rack, or to edit an existing rack in the database (60), which is addressed in FIGS. 3, 4, 5. If the user answers yes to the question (50), the user will be asked the question, what is the type of equipment? (70), addressing the use of grouping equipment in the database by type. The reason is that the query of tables in the database will be faster if grouped by type. The user will be asked another question, what is the number of equipment to be added to the rack? (80), addressing the user might only want to place a rack in the system or add a number of equipment to the rack.

If the user answers (0 or None) to the question, do you want to build another rack? (90), the user will be able to exit the new rack section (100). If the user answers (1 or more) to the question, do you want to build another rack? (90), the user will be prompted to answer a series of questions (110), (120), (130), (140), (150), which can be inputted by a variety of input methods, barcode reader, Personal Digital Assistant, Keyboard and/or Mouse or Voice Input.

The application server will utilize a mathematical equation (200) to calculate whether there is available space (30) in the rack (10) to fit the equipment (20) to the added to the rack (10). If the equipment (20) does not fit the available space, then the user will be prompted that the Equipment will not fit in the available space (125), where the user can try to find available space (30) in the existing rack section (60) or try to add a different name (110) of equipment (20).

The method of creating a rack (10) is always from adding of equipment (20) the bottom to the top, with position numbers (40) starting from number one.

Turning back to FIG. 2, after the user adds a new piece of equipment (20), the user will be prompted to another question, Do you want to add more equipment? (160), where the user can add more equipment (20) by the series of questions (110), (120), (130), (140), (150). If the user does not wish to add more equipment (20) to this rack (10), the user will be sent to answer the question; do you want to build another rack? (90), where the user will be able to exit the new rack section (100) or stay in the new rack section (50) to build a new rack (10).

Description—FIG. 3

The user has the ability to edit existing racks, with the rack frame only (10), by answering the question, is this an existing rack? (170), shown on FIG. 3. The user has two choices to start viewing the dynamic creation of the rack (10). If the user answers yes to the question (170), the user will be prompted to another question, are you adding, removing or changing equipment (20)? (180), addressing if the user wants to add equipment (20) to an existing rack (10), remove equipment (20) from an existing rack (10) or change equipment (20) in an existing rack (10). The reason is to track the life cycle of equipment and depict these changes from the field inside of the database.

If the user answers no to the question (170), the user will be sent to new rack section (175).

If the answer to question (180) is removing, then the user will be asked another question, what is the position number (40) on the rack? (190), addressing which equipment (20) to be removed from the rack (10). The user will then be prompted with yet another question, do you want to remove additional equipment from this rack? (200), if the answer is yes, then the user will be sent back to the question (190), addressing the next position number (40) to be removed. If the user answers no, then the user will be asked to answer another question (210), Do you want to add equipment (20) to this rack (10)? where the user can answer no, to be prompted to answer the next question (220), Do you want edit another existing rack (10)?. The user can either exit the existing rack section (230) or start over and return to the beginning of the existing rack section with question (170).

If the user answers yes to question (210), then the user will be sent back to question (180) to either add, remove or change equipment (20) or start over the editing process of the existing racks.

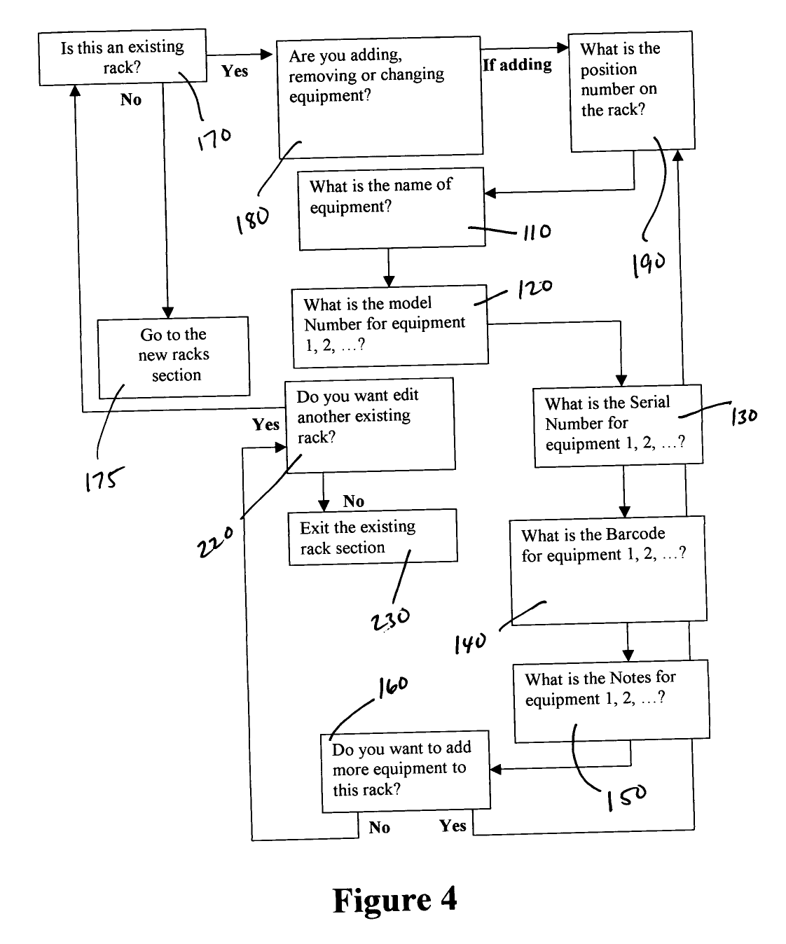

Description—FIG. 4

The user has the ability to edit existing racks, with the rack frame only (10), by answering the question, is this an existing rack? (170), shown on FIG. 4. The user has two choices to start viewing the dynamic creation of the rack (10). If the user answers yes to the question (170), the user will be prompted to another question, are you adding, removing or changing equipment (20)? (180), addressing if the user wants to add equipment (20) to an existing rack (10), remove equipment (20) from an existing rack (10) or change equipment (20) in an existing rack (10).

If the user answers no to the question (170), the user will be sent to new rack section (175).

If the answer to question (180) is adding, then the user will be asked another question, what is the position number (40) on the rack? (190). Then, the user will be prompted to answer a series of questions (110), (120), (130), (140), (150), which can be inputted by a variety of input methods, barcode reader, Personal Digital Assistant, Keyboard and/or Mouse or Voice Input.

The user will then be prompted with yet another question, do you want to add more equipment to this rack? (160), if the answer is yes, then the user will be sent back to the question (190), addressing the next position number (40) to be added. If the user answers no, then the user will be asked to answer another question (220); do you want to edit another existing rack (10)? where the user can answer no, can exit the existing rack section (230).

If the user answers yes to the question (220), then the user will be sent to start over and return to the beginning of the existing rack section with question (170).

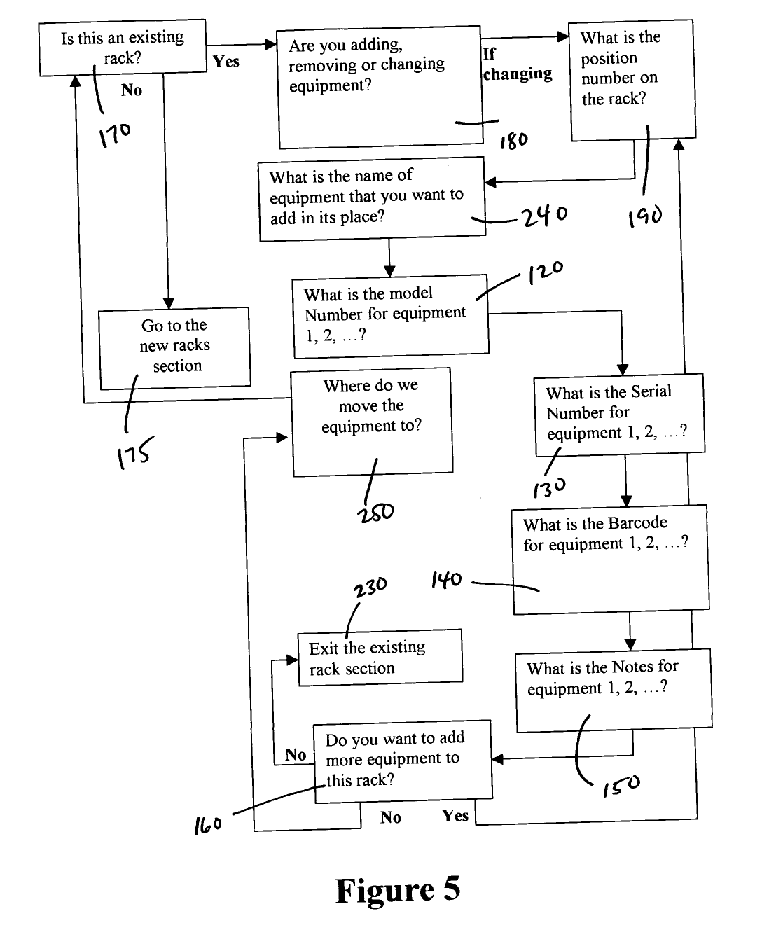

Description—FIG. 5

The user has the ability to edit existing racks, with the rack frame only (10), by answering the question, is this an existing rack? (170), shown on FIG. 5. The user has two choices to start viewing the dynamic creation of the rack (10). If the user answers yes to the question (170), the user will be prompted to another question, are you adding, removing or changing equipment (20)? (180), addressing if the user wants to add equipment (20) to an existing rack (10), remove equipment (20) from an existing rack (10) or change equipment (20) in an existing rack (10).

If the user answers no to the question (170), the user will be sent to new rack section (175).

If the answer to question (180) is changing, then the user will be asked another question, what is the position number (40) on the rack? (190). Then, the user will be prompted to answer a series of questions (240), (120), (130), (140), (150), which can be inputted by a variety of input methods, barcode reader, Personal Digital Assistant, Keyboard and/or Mouse or Voice Input.

The user will then be prompted with yet another question, do you want to add more equipment to this rack? (160), if the answer is yes, then the user will be sent back to the question (190), addressing the next position number (40) to be added. If the user answers no, then the user will be asked to answer another question (250); where do we move the equipment (20)? where the user is sent to start the existing rack section (170) for adding equipment (20) to another rack (10). Or if they answer no to question (160), the user has the option to exit the existing rack section (230).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process and method for a dynamic rack creator and editor, comprising:
a mathematical equation and/or equations, which are responsive to input by the user thereby maintaining (or managing) space, height and depth requirements for both the racks and equipment;
a data entry method to receive input from barcode readers to create and edit racks dynamically;
a data entry method to receive input from voice input to create and edit racks dynamically;
a data entry method to receive input from a keyboard and/or mouse to create and edit racks dynamically;
a data entry method to receive input from personal digital assistant to create and edit racks dynamically.

2. A method as recited in claim 1, wherein the dynamic rack creator and editor utilizes a graphical user interface (GUI) is used to input data to access a database server to acquire images and/or create images to determine the correct placement in the visual representation of the creation and/or update of a network rack and equipment dynamically (or in real-time).

3. A method as recited in claim 1, wherein the dynamic rack creator and editor automates the creation of details of the network infrastructure, involving a series of racks and equipment.

4. A method as recited in claim 3, wherein the dynamic rack creator and editor provides a method to automate the update of details of the network infrastructure, involving a series of racks and equipment in real-time (or dynamically).

5. A method as recited in claim 3, wherein the dynamic rack creator and editor tracks network rack and equipment within an application server that can be accessed by a database server for the purposes of accessing and input of moves, adds and changes records over time for historical data on equipment and maintenance purposes.

6. A method as recited in claim 1, wherein the dynamic rack creator and editor assists network planning on the data center, switch room, and central office, based upon the ability to see visually exactly what resides within each data center, switch room, and central office, via the Internet or Intranet.

7. A method as recited in claim 1, wherein the dynamic rack creator and editor enables the visual representation of the equipment details, including height, width and depth measurements in (“U” or units), inches or centimeters, and model numbers, serial numbers and other rack and/or equipment details.

8. A method as recited in claim 1, wherein the dynamic rack creator and editor provides tracking of the life cycle of networking equipment and inventory records, whether its new, retired in place or moved, throughout the data center, switch room, and central office.

9. A method as recited in claim 1, wherein the dynamic rack creator and editor provides grouping of equipment, by equipment type, and dimensions (height, depth and width).

10. A method as recited in claim 1, wherein the dynamic rack creator and editor provides input of space and height requirements for both the racks and equipment by barcode readers, voice input, personal digital assistants, and keyboard and/or mouse input devices to create and edit racks dynamically.

11. A method as recited in claim 1, wherein the dynamic rack creator and editor provides input of equipment model numbers, barcode and serial numbers for the equipment by barcode readers, voice input, personal digital assistants, and keyboard and/or mouse to create and edit racks dynamically.

12. A method as recited in claim 1, wherein the dynamic rack creator and editor provides the capability to search (or query) a database server for available equipment to place in open or vacant space on the rack, which meet a series of height, depth, width requirements.
